(19) United States
(12) Patent Application Publication
(10) Pub. No.: US 2022/0177317 A1
(43) Pub. Date: Jun. 9, 2022

(54) MULTI-ELEMENT-COATING SILICON-BASED COMPOSITE MATERIAL WITH HIGH INITIAL EFFICIENCY, METHOD FOR PREPARING SAME, AND USE THEREOF

(71) Applicant: Guangdong Kaijin New Energy Technology Co., Ltd., Dongguan (CN)

(72) Inventors: Anhua ZHENG, Dongguan (CN); Dexin YU, Dongguan (CN); Yongjun YANG, Dongguan (CN)

(73) Assignee: Guangdong Kaijin New Energy Technology Co., Ltd., Dongguan (CN)

(21) Appl. No.: 17/489,891

(22) Filed: Sep. 30, 2021

(30) Foreign Application Priority Data
Dec. 7, 2020 (CN) 202011417888.0
Jun. 9, 2021 (CN) 202110641316.9

(51) Int. Cl. C01B 33/12

(52) U.S. Cl. CPC C01B 33/12; B82Y 30/00

(57) ABSTRACT

A multi-element-coating silicon-based composite material with high initial efficiency consists of a plurality of multi-element nano-silicon particle and a modified layer; the multi-element nano-silicon particle includes a first nano-silicon layer, a nano-silicon oxide layer, a second nano-silicon layer and a carbon coating layer in sequence from inside to outside; and the filled and modified layer is a carbon filled and modified layer. The present invention provides the multi-element-coating silicon-based composite material with high initial efficiency, a method for preparing the same, and a use thereof. The multi-element-coating silicon-based composite material with high initial efficiency is simple and practicable in process and stable in product performance, and has good application prospects.

### FIELD

The present invention relates to the field of anode materials for batteries, and in particular, relates to a multi-element-coating silicon-based composite material with high initial efficiency, a method for preparing the same, and a use thereof.

### BACKGROUND

At present, commercial anode materials are mainly graphite materials such as natural graphite, artificial graphite, and intermediate phases thereof, which however, due to their low theoretic capacity (372 mAh/g), cannot meet the market needs. In recent years, the attention of people has focused on novel anode materials with high specific capacity, such as lithium storage metals (such as Sn and Si) and oxides thereof, as well as lithium transition metal phosphides. Among numerous novel anode materials with high specific capacity, Si due to its high theoretical specific capacity (4200 mAh/g) has become one of the most potential alternatives to graphite materials. However, Si-based materials show a great volumetric effect during a charge/discharge process, and are likely to undergo cracking and dusting and lose contact with a current collector, leading to a sharp decrease of cycle performance. In addition, the silicon-based materials have low intrinsic conductivity and poor rate performance. Therefore, how to reduce the volumetric expansion effect and improve the cycle performance and rate performance has great significance in the application of the silicon-based materials in lithium-ion batteries.

At present, one of the most popular methods for improving the volumetric effect of a silicon material is to nanometerize silicon, and there are mainly two methods for preparing nano-silicon, namely, a silane pyrolysis method and a physical ball milling method. A chemical synthesis method has harsh conditions and thus is difficult to apply on a large scale for preparing the nano-silicon. In a process of preparing the anno-silicon through physical ball-milling, it is inevitable that a very thick oxide layer is present on a surface of the nano-silicon. The oxide layer of the nano-silicon consumes lithium during an initial charge/discharge process, leading to low initial coulombic efficiency of the material. Therefore, how to reduce the oxygen content in the nano-silicon and improve the initial coulombic efficiency has a great significance in the application of silicon-based materials in lithium-ion batteries.

### SUMMARY

To solve the technical problems described above, the present invention provides a multi-element-coating silicon-based composite material with high initial efficiency, a method for preparing the same, and a use thereof. The multi-element-coating silicon-based composite material with high initial efficiency is simple and practicable in process and stable in product performance, and has good application prospects.

The present invention employs the following technical solution:

a multi-element-coating silicon-based composite material with high initial efficiency consists of at least one multi-element nano-silicon particle and a filled and modified layer, wherein the multi-element nano-silicon particle includes a first nano-silicon layer, a nano-silicon oxide layer, a second nano-silicon layer and a carbon coating layer in sequence from inside to outside; and the filled and modified layer is a carbon filled and modified layer.

As a further improvement of the technical solution described above, the multi-element nano-silicon particle has a particle size D50 of 30-150 nm; and the multi-element nano-silicon particle has an oxygen content of 0-20%.

As a further improvement of the technical solution described above, the second nano-silicon layer has a thickness of 2-30 nm.

As a further improvement of the technical solution described above, the carbon coating layer has a thickness of 3-100 nm.

As a further improvement of the technical solution described above, at least one carbon filled and modified layer is provided, with a monolayer thickness of 0.2-1.0 μm.

A method for preparing a multi-element-coating silicon-based composite material with high initial efficiency includes the following steps:

S0: mixing and dispersing nano-silicon, metal powder, and a binder in an organic solvent evenly, and performing spraying to prepare a precursor A;

S1: performing high-temperature treatment on the precursor A to prepare a precursor B;

S2: performing acid washing, filtering, and drying on the precursor B to prepare a precursor C; and

S3: performing carbon filling and coating on the precursor C to prepare the multi-element-coating silicon-based composite material with high initial efficiency.

As a further improvement of the technical solution described above, in Step S1, a method for the high-temperature treatment includes: raising the temperature to 600-1050° C. at a rate of 1-10° C./min, and preserving heat for 2-10 h.

As a further improvement of the technical solution described above, in Step S2, a solution used in the acid washing is one or more of hydrochloric acid, nitric acid, hydrofluoric acid, and diluting solutions thereof, and the filtering is one of suction filtering, centrifuging, or press filtering.

As a further improvement of the technical solution described above, in Step S3, the carbon filling and coating is one or more of a liquid phase, a solid phase or a vapor phase; and the multi-element-coating silicon-based composite material with high initial efficiency has an initial reversible capacity being not less than 1400 mAh/g and an efficiency being ≥85%.

A use of a multi-element-coating silicon-based composite material with high initial efficiency is provided, wherein the multi-element-coating silicon-based composite material with high initial efficiency is applicable to an anode material of a lithium-ion battery.

The present invention has the following beneficial effects:

In the multi-element-coating silicon-based composite material with high initial efficiency according to the present invention, the intermediate nano-silicon oxide layer can effectively alleviate the volumetric effect during the charge/discharge process, thereby effectively preventing the material from dusting during cycle processes; the secondary outermost nano-silicon layer can reduce the irreversible consumption of lithium, thereby improving the initial efficiency of the lithium; the outermost carbon coating layer can effectively improve the conductivity of the silicon-based material and reduce side reactions by preventing the nano-silicon from directly contacting electrolytes, and meanwhile, can effectively alleviate the volumetric effect during the charge/discharge process; and the filled and modified layer can reduce the side reactions by preventing the nano-silicon from directly contacting the electrolytes, and meanwhile, can further effectively improve the conductivity of the silicon-based material and alleviate volumetric effect energy during the charge/discharge process.

### BRIEF DESCRIPTION OF THE DRAWINGS

FIG. 1 is a schematic structural diagram of multi-element nano-silicon particle of a multi-element-coating silicon-based composite material with high initial efficiency according to the present invention:

FIG. 2 is a schematic structural diagram of the multi-element-coating silicon-based composite material with high initial efficiency according to the present invention;

FIG. 3 is a scanning electron microscope graph of a material from Embodiment 2 of the multi-element-coating silicon-based composite material with high initial efficiency according to the present invention; and

FIG. 4 shows initial charge/discharge curves of the material from Embodiment 2 of the multi-element-coating silicon-based composite material with high initial efficiency according to the present invention.

### DESCRIPTION OF THE EMBODIMENTS

The technical solutions in the embodiments of the present invention will be described clearly and completely below in conjunction with the embodiments of the present invention.

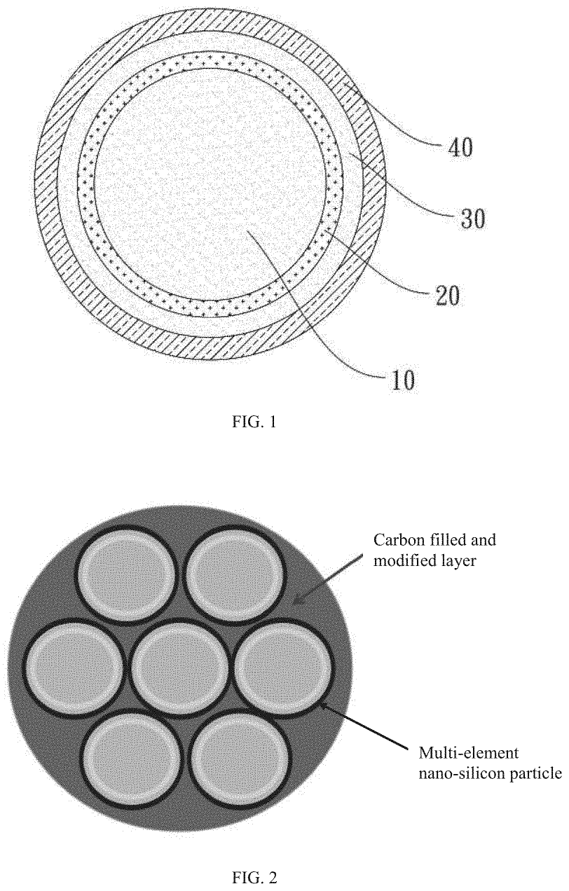

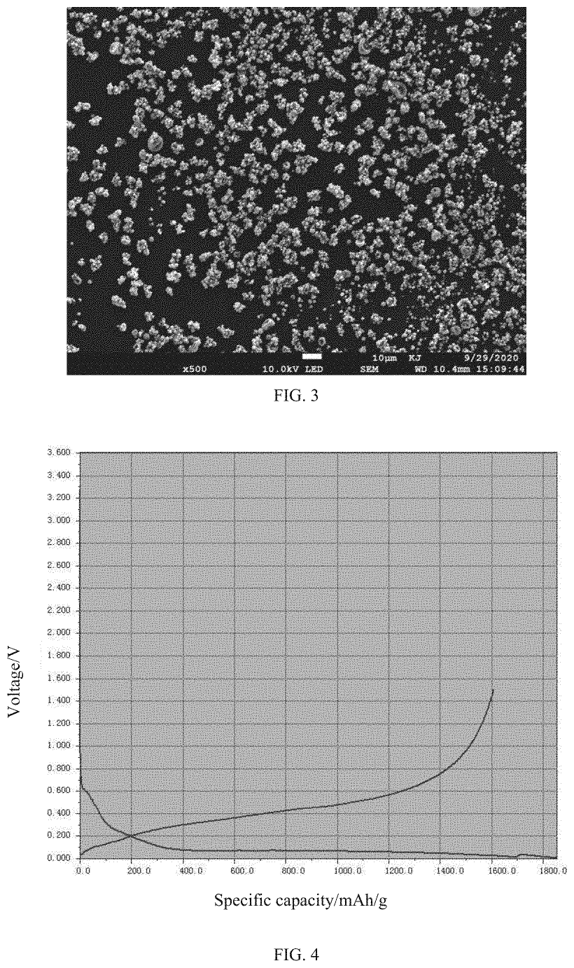

As shown in FIG. 1 and FIG. 2, a multi-element-coating silicon-based composite material with high initial efficiency consists of a plurality of multi-element nano-silicon particles and a filled and modified layer, wherein the multi-element nano-silicon particle includes a first nano-silicon layer 10, a nano-silicon oxide layer 20, a second nano-silicon layer 30, and a carbon coating layer 40 in sequence from inside to outside; and the filled and modified layer is a carbon filled and modified layer.

The multi-element nano-silicon particle has a particle size D50 of 30-150 nm, further preferably 30-110 nm, and particularly preferably 50-100 nm; and the multi-element nano-silicon particle is at least one in number.

The multi-element nano-silicon particle has an oxygen content of 0-20%, further preferably 0-15%, and particularly preferably 0-10%.

The second nano-silicon layer 30 has a thickness of 2-30 nm, further preferably 3-20 nm, and particularly preferably 3-10 nm.

The carbon coating layer 40 has a thickness of 3-100 nm, further preferably 3-60 nm, and particularly preferably 3-30 nm.

At least one carbon filled and modified layer is provided, with a monolayer thickness of 0.2-1.0 μm. Material of the carbon filled and modified layer is filled between the multi-element nano-silicon particles and covers the multi-element nano-silicon particles.

A method for preparing a multi-element-coating silicon-based composite material with high initial efficiency includes the following steps:

S0: mixing and dispersing nano-silicon, metal powder, and a binder in an organic solvent evenly, and performing spraying to obtain a precursor A;

S1: performing high-temperature treatment on the precursor A to obtain a precursor B;

S2: performing acid washing, filtering, and drying on the precursor B to prepare a precursor C; and

S3: performing carbon filling and coating on the precursor C to obtain the multi-element-coating silicon-based composite material with high initial efficiency.

The nano-silicon is nano-silicon oxide, and has an oxygen content of 0-20%, further preferably 0-15%, and particularly preferably 0-10%.

In Step S0, the metal powder is one or both of Mg and Al.

In Step S0, the binder is one or more of sucrose, glucose, citric acid, phenolic resin, epoxy resin, asphalt, polyvinyl alcohol, polypyrrole, polypyrrolidone, and PVDF.

In Step S0, the organic solvent is one or a mixture of several of an oil solvent, an alcohol solvent, a ketone solvent, an alkane solvent, n-methylpyrrolidone, tetrahydrofuran, and toluene. The oil solvent is one or a mixture of several of kerosene, mineral oil, and vegetable oil; the alcohol solvent is one or a mixture of several of ethanol, methaneol, ethylene glycol, isopropanol, n-octyl alcohol, propenol, and octanol; the ketone solvent is one or a mixture of several of acetone, methyl butanone, methylisobutylketone, methyl ethyl ketone, methyl isoacetone, cyclohexanone, and methyl hexanone; and the alkane solvent is one or a mixture of several of cyclohexane, n-hexane, isoheptane, 3,3-dimethylpentane, and 3-methylhexane.

In Step S1, a method for the high-temperature treatment includes: raising the temperature to 600-1050° C. at a rate of 1-10° C./min, and preserving the heat for 2-10 h, wherein the protective atmosphere is one or more of nitrogen, argon, helium, hydrogen, and an argon-hydrogen mixed gas.

In Step S2, a solution used in the acid washing is one or more of hydrochloric acid, nitric acid, hydrofluoric acid, and diluting solutions thereof, and the filtering is one of suction filtering, centrifuging, or press filtering.

In Step S3, the carbon filling and coating is one or more of a liquid phase carbon filling and coating, a solid phase carbon filling and coating, or a vapor phase carbon filling and coating; and the multi-element-coating silicon-based composite material with high initial efficiency has an initial reversible capacity being not less than 1400 mAh/g and an efficiency being ≥85%.

In Step S3, the carbon filling and coating is any one of pyrolyzed carbon filling and coating, or vapor-phase carbon filling and coating, or liquid-phase carbon filling and coating, with a monolayer thickness of 0.2-1.0 μm.

The liquid-phase carbon filling and coating includes the following steps: mixing an organic carbon source, an object to be coated, and a solvent at high speed to disperse the same evenly to obtain a slurry; spraying and drying the slurry; and thermally treating a resultant.

The vapor-phase carbon filling and coating includes the following steps: placing an object to be coated in a reactor; introducing a protective gas into the reactor; increasing the temperature of the reactor to 400-1000° C. at a rate of 1-5° C./min; introducing an organic carbon source gas at an introduction rate of 0.5-20.0 L/min into the reactor; preserving the heat of the reactor for 0.5-20 h; and naturally cooling the reactor to room temperature to obtain a vapor-phase coating product.

Preferably, the organic carbon source includes one or more of methane, ethane, propane, isopropane, butane, isobutane, ethylene, propylene, acetylene, butene, vinyl chloride, vinyl fluoride, vinyl difluoride, chloroethane, fluoroethane, difluoroethane, chloromethane, fluoromethane, difluoromethane, trifluoromethane, methylamine, formaldehyde, benzene, toluene, xylene, styrene, and phenol.

A use of a multi-element-coating silicon-based composite material with high initial efficiency is provided, wherein the multi-element-coating silicon-based composite material with high initial efficiency is applicable to an anode material of a lithium-ion battery.

Preferably, the multi-element-coating silicon-based composite material with high initial efficiency has a particle size D50 of 2-30 μm, further preferably 2-20 μm, and particularly preferably 2-10 μm.

Preferably, the multi-element-coating silicon-based composite material with high initial efficiency has a specific surface area of 1-15 m²/g, further preferably 1-10 m²/g, and particularly preferably 1-5 m²/g.

Preferably, the multi-element-coating silicon-based composite material with high initial efficiency has an oxygen content of 0-10%, further preferably 0-8%, and particularly preferably 0-5%.

Preferably, the multi-element-coating silicon-based composite material with high initial efficiency has a carbon content of 20-90%, further preferably 20-60%, and particularly preferably 30-50%.

Preferably, the multi-element-coating silicon-based composite material with high initial efficiency has a silicon content of 5-90%, further preferably 20-70%, and particularly preferably 30-60%.

### Embodiment 1

1. 100 g of nano-silicon with a particle size D50 of 100 nm, 5 g of magnesium powder, and 10 g of citric acid were mixed and dispersed evenly in ethyl alcohol, and then sprayed to obtain a precursor A1;

2. The precursor A1 was sintered under a condition of a nitrogen protective atmosphere, wherein a temperature rise rate was 1° C./min, the sintering temperature is 1000° C., and heat was preserved for 5 h; and a resultant was cooled to obtain a precursor B1;

3. The precursor B1 and diluted hydrochloric acid with a concentration of 5% were mixed at a mass ratio of 1:5, and then subjected to acid washing, water washing, suction filtration, and drying to obtain a precursor C1; and

4. The precursor C1 and asphalt were fused at a mass ratio of 10:3, and subsequently sintered under a condition of a nitrogen protective atmosphere, wherein a temperature rise rate was 1° C./min, the sintering temperature is 1000° C., and heat was preserved for 5 h; and a resultant was cooled to obtain the multi-element-coating silicon-based composite material with high initial efficiency.

### Embodiment 2

1. 100 g of nano-silicon with a particle size D50 of 100 nm, 3 g of magnesium powder, and 10 g of citric acid were mixed and dispersed evenly in ethyl alcohol, and then sprayed to obtain a precursor A2;

2. The precursor A2 was sintered under a condition of a nitrogen protective atmosphere, wherein a temperature rise rate was 1° C./min, the sintering temperature is 1000° C., and heat was preserved for 5 h; and a resultant was cooled to obtain a precursor B2;

3. The precursor B2 and diluted hydrochloric acid with a concentration of 5% were mixed at a mass ratio of 1:5, and then subjected to acid washing, water washing, suction filtration, and drying to obtain a precursor C2; and

4. The precursor C2 and asphalt were fused at a mass ratio of 10:3, and subsequently sintered under a condition of a nitrogen protective atmosphere, wherein a temperature rise rate was 1° C./min, the sintering temperature is 1000° C., and heat was preserved for 5 h; and a resultant was cooled to obtain the multi-element-coating silicon-based composite material with high initial efficiency.

### Embodiment 3

1. 100 g of nano-silicon with a particle size D50 of 100 nm, 7 g of magnesium powder, and 10 g of citric acid were mixed and dispersed evenly in ethyl alcohol, and then sprayed to prepare a precursor A3;

2. The precursor A3 was sintered under a condition of a nitrogen protective atmosphere, wherein a temperature rise rate was 1° C./min, the sintering temperature is 1000° C., and heat was preserved for 5 h; and a resultant was cooled to prepare a precursor B3;

3. The precursor B3 and diluted hydrochloric acid with a concentration of 5% were mixed at a mass ratio of 1:5, and then subjected to acid washing, water washing, suction filtration, and drying to prepare a precursor C3; and

4. The precursor C3 and asphalt were fused at a mass ratio of 10.3, and subsequently sintered under a condition of a nitrogen protective atmosphere, where a temperature rise rate was 1° C./min, thermal treatment was performed at the temperature of 1000° C., and heat was preserved for 5 h; and a resultant was cooled to prepare the multi-element-coating silicon-based composite material with high initial efficiency.

### Embodiment 4

1. 100 g of nano-silicon with a particle size D50 of 100 nm, 3 g of magnesium powder, and 10 g of citric acid were mixed and dispersed evenly in ethyl alcohol, and then sprayed to prepare a precursor A4;

2. The precursor A4 was sintered under a condition of a nitrogen protective atmosphere, where a temperature rise rate was 1° C./min, thermal treatment was performed at the temperature of 1000° C., and heat was preserved for 5 h; and a resultant was cooled to prepare a precursor B4;

3. The precursor B4 and diluted hydrochloric acid with a concentration of 5% were mixed at a mass ratio of 1:5, and then subjected to acid washing, water washing, suction filtration, and drying to prepare a precursor C4; and

4. 100 g of the prepared precursor C4 was placed in a CVD furnace and heated to 1000° C. at a temperature rise rate of 5° C./min; high-purity nitrogen and a methane gas were respectively introduced into the CVD furnace at rates of 4.0 L/min and 0.5 L/min, and a duration for introducing the silane gas was 4 h: and a resultant was cooled to room temperature to obtain the multi-element-coating silicon-based composite material with high initial efficiency.

### Embodiment 5

1. 100 g of nano-silicon with a particle size D50 of 100 nm, 3 g of magnesium powder, and 10 g of citric acid were mixed and dispersed evenly in ethyl alcohol, and then sprayed to prepare a precursor A5;

2. The precursor A5 was sintered under a condition of a nitrogen protective atmosphere, where a temperature rise rate was 1° C./min, thermal treatment was performed at the temperature of 1000° C., and heat was preserved for 5 h; and a resultant was cooled to prepare a precursor B5;

3. The precursor B5 and diluted hydrochloric acid with a concentration of 5% were mixed at a mass ratio of 1:5, and then subjected to acid washing, water washing, suction filtration, and drying to prepare a precursor C5;

4. The precursor C5 and asphalt were fused at a mass ratio of 10:2, and subsequently sintered under a condition of a nitrogen protective atmosphere, where a temperature rise rate was 1° C./min, thermal treatment was performed at the temperature of 1000° C., and heat was preserved for 5 h, and a resultant was cooled to prepare a precursor D5; and

5. 100 g of the prepared precursor D4 was placed in the CVD furnace and heated to 1000° C. at a temperature rise rate of 5° C./min; the high-purity nitrogen and the methane gas were respectively introduced into the CVD furnace at rates of 4.0 L/min and 0.5 L/min, and a duration for introducing the silane gas was 0.5 h; and a resultant was cooled to prepare the multi-element-coating silicon-based composite material with high initial efficiency.

### Embodiment 6

1. 100 g of nano-silicon with a particle size D50 of 100 nm, 5 g of aluminum powder, and 10 g of citric acid were mixed and dispersed evenly in ethyl alcohol, and then sprayed to prepare a precursor A6;

2. The precursor A6 was sintered under a condition of a nitrogen protective atmosphere, where a temperature rise rate was 1° C./min, thermal treatment was performed at the temperature of 1000° C., and heat was preserved for 5 h; and a resultant was cooled to prepare a precursor B6;

3. The precursor B6 and diluted hydrochloric acid with a concentration of 5% were mixed at a mass ratio of 1:5, and then subjected to acid washing, water washing, suction filtration, and drying to prepare a precursor C6; and

4. The precursor C6 and asphalt were fused at a mass ratio of 10:3, and subsequently sintered under a condition of a nitrogen protective atmosphere, where a temperature rise rate was 1° C./min, thermal treatment was performed at the temperature of 1000° C., and heat was preserved for 5 h; and a resultant was cooled to obtain a multi-element-coating silicon-based composite material with high initial efficiency.

### Comparative Example 1

1. 100 g of nano-silicon with a particle size D50 of 100 nm and 10 g of citric acid were mixed and dispersed evenly in ethyl alcohol, and then sprayed to prepare a precursor A0;

2. The precursor A0 was sintered under a condition of a nitrogen protective atmosphere, where a temperature rise rate was P° C./min, thermal treatment was performed at the temperature of 1000° C., and heat was preserved for 5 h; and a resultant was cooled to prepare a precursor B0;

3. The precursor B0 and asphalt were fused at a mass ratio of 10:3, and subsequently sintered under a condition of a nitrogen protective atmosphere, wherein a temperature rise rate was 1° C./min, thermal treatment was performed at the temperature of 1000° C., and heat was preserved for 5 h; and a resultant was cooled to obtain a multi-element-coating silicon-based composite material.

Initial-cycle tests were performed by using the composite materials prepared in Comparative Example 1 and Embodiments 1 to 6 as anode materials.

Test conditions: the materials prepared in the comparative example and the embodiments were applied as anode materials and mixed with a binder polyvinylidene fluoride (PVDF) and a conductive agent (Super-P) at a mass ratio of 70:15.15: a proper amount of N-methylpyrrolidone (NMP) was added into the mixture as a solvent to prepare a slurry which was coated on a copper foil; the coated copper foil was vacuum dried and rolled to prepare an anode piece; a metal lithium piece was used as a counter electrode, electrolyte obtained by using 1 mol/L of LiPF6 three-component mixed solvent at a mixing ratio of EC:DMC:EMC=1:1:1(v/v) was used, and a polypropylene microporous membrane was used as a separator diaphragm; and a CR2032 type button battery was assembled in a glove box filled with an inert gas. A charge/discharge test of the button battery was performed on a battery test system in Landian Electronics (Wuhan) Co., Ltd. The charge/discharge occurred at 0.1 C at constant temperature, and a charge/discharge voltage was limited to 0.005-1.5 V.

As shown in the table below, Table 1 shows the results of the initial-cycle tests of the comparative example and the embodiments.

TABLE 1

| | Initial charge | Initial discharge | Initial |
|---|---|---|---|
| | specific capacity | specific capacity | coulombic |
| | (mAh/g) | (mAh/g) | efficiency (%) |
| Comparative | 1414.3 | 1710.2 | 82.7 |
| Example 1 | | | |
| Embodiment 1 | 1653.5 | 1851.6 | 89.3 |
| Embodiment 2 | 1611.2 | 1849.7 | 87.1 |
| Embodiment 3 | 1689.2 | 1850.2 | 91.3 |
| Embodiment 4 | 1623.5 | 1849.1 | 87.8 |
| Embodiment 5 | 1621.5 | 1853.1 | 87.5 |
| Embodiment 6 | 1589.4 | 1850.3 | 85.9 |

In the multi-element-coating silicon-based composite material with high initial efficiency according to the present invention, the intermediate nano-silicon oxide layer can effectively alleviate the volumetric effect during the charge/discharge process, thereby effectively preventing the material from dusting during a cycle process; the secondary outermost nano-silicon layer can reduce the irreversible consumption of lithium, thereby improving the initial efficiency of the lithium, the outermost carbon coating layer can effectively improve the conductivity of the silicon-based material and reduce side reactions by preventing the nano-silicon from directly contacting electrolytes, and meanwhile, can effectively alleviate the volumetric effect during the charge/discharge process; and the filled and modified layer can reduce the side reactions by preventing the nano-silicon from directly contacting the electrolytes, and meanwhile, can further effectively improve the conductivity of the silicon-based material and alleviate volumetric effect energy during the charge/discharge process.

The embodiments above only provide specific and detailed descriptions of several implementations of the present invention, and therefore should not be construed to limit the patent scope of the present invention. It should be noted that several variations and improvements can be made by those of ordinary skills in the art without departing from the concept of the present invention, and shall be construed as falling within the protection scope of the present invention. Therefore, the patent protection scope of the present invention shall be subjected to the accompanying claims.

What is claimed is:

1. A multi-element-coating silicon-based composite material with high initial efficiency, consisted of at least one multi-element nano-silicon particle and a filled and modified layer, wherein the at least one multi-element nano-silicon particle comprises a first nano-silicon layer, a nano-silicon oxide layer, a second nano-silicon layer and a carbon coating layer in sequence from inside to outside, and the filled and modified layer is a carbon filled and modified layer.

2. The multi-element-coating silicon-based composite material with high initial efficiency according to claim 1, wherein the multi-element nano-silicon particle has a particle size D50 of 30-150 nm.

3. The multi-element-coating silicon-based composite material with high initial efficiency according to claim 1, wherein the at least one multi-element nano-silicon particle comprises a plurality of multi-element nano-silicon particles.

3. The multi-element-coating silicon-based composite material with high initial efficiency according to claim 1, wherein the multi-element nano-silicon particle has an oxygen content of 0-20%.

4. The multi-element-coating silicon-based composite material with high initial efficiency according to claim 1, wherein the second nano-silicon layer has a thickness of 2-30 nm.

5. The multi-element-coating silicon-based composite material with high initial efficiency according to claim 1, wherein the carbon coating layer has a thickness of 3-100 nm.

6. The multi-element-coating silicon-based composite material with high initial efficiency according to claim 1, wherein at least one carbon filled and modified layer is provided, with a monolayer thickness of 0.2-1.0 μm.

7. The multi-element-coating silicon-based composite material with high initial efficiency according to claim 1, wherein the multi-element-coating silicon-based composite material has an initial reversible capacity greater than or equal to 1400 mAh/g.

8. The multi-element-coating silicon-based composite material with high initial efficiency according to claim 1, wherein the multi-element-coating silicon-based composite material has an efficiency being greater than or equal to 5%.

9. A method for preparing a multi-element-coating silicon-based composite material with high initial efficiency, comprising the following steps:
S0: mixing and dispersing nano-silicon, metal powder, and a binder in an organic solvent evenly, and performing spraying to obtain a precursor A;
S1: performing high-temperature treatment on the precursor A to obtain a precursor B;
S2: performing acid washing, filtering, and drying on the precursor B to obtain a precursor C; and
S3: performing carbon filling and coating on the precursor C to obtain the multi-element-coating silicon-based composite material with high initial efficiency.

10. The method for preparing the multi-element-coating silicon-based composite material with high initial efficiency according to claim 9, wherein in S1, a method for the high-temperature treatment comprises: raising a temperature to 600-1050° C. at a rate of 1-10° C./min, and preserving heat for 2-10 h.

11. The method for preparing the multi-element-coating silicon-based composite material with high initial efficiency according to claim 9, wherein in S2, a solution used in the acid washing is one or more of hydrochloric acid, nitric acid, hydrofluoric acid, and diluting solutions thereof, and the filtering is one of suction filtering, centrifuging, and press filtering.

12. The method for preparing the multi-element-coating silicon-based composite material with high initial efficiency according to claim 9, wherein in S3, the carbon filling and coating is one or more of a liquid phase carbon filling and coating, a solid phase carbon filling and coating or a vapor phase carbon filling and coating.

13. The method for preparing the multi-element-coating silicon-based composite material with high initial efficiency according to claim 9, wherein the multi-element-coating silicon-based composite material with high initial efficiency has an initial reversible capacity being not less than 1400 mAh/g and an efficiency being ≥85%.

14. A use of a multi-element-coating silicon-based composite material with high initial efficiency, wherein the multi-element-coating silicon-based composite material with high initial efficiency is applicable to an anode material of a lithium-ion battery.
